(19) United States
(12) Patent Application Publication
(10) Pub. No.: US 2004/0024373 A1
(43) Pub. Date: Feb. 5, 2004

(54) Method and device for correcting or reducing the formation of facial lines

(75) Inventors: Semyon Ioffe, Winnipeg (CA); Anna Chernyakhovsky, Winnipeg (CA)

Correspondence Address: OGILVY RENAULT, 1981 MCGILL COLLEGE AVENUE, SUITE 1600, MONTREAL, QC, H3A2Y3, CA

(73) Assignee: Anna Chernyakhovsky

(21) Appl. No.: 10/397,828

(22) Filed: Mar. 27, 2003

Related U.S. Application Data
(63) Continuation of application No. 09/410,078, filed on Oct. 1, 1999, now abandoned.

(51) Int. Cl. A61H 33/04

(52) U.S. Cl. 604/303

(57) ABSTRACT

A method for reducing the formation of lines on the skin of a person's face and neck (and/or at least partly removing such lines) comprises applying pressure on the skin at locations where a reduction in the formation of lines (or a reduction of lines) is desired with this pressure being sufficient for at least partly impeding the development of these lines by causing the person in time to diminish his/her formation of facial expressions which cause the skin to wrinkle. If the pressure is applied for a prolonged period of time, biofeedback between the brain, muscles and skin subconsciously cause the person to reduce making such facial expressions. The device is a compression and face stabilising device which comprises a mask and/or one or more bands adapted to be positioned on the skin at the aforementioned locations, and an attachment mechanism to secure the mask to the head and/or neck of the person and which is adapted to apply sufficient pressure at such locations for at least partly impeding the development of lines thereat.

### CRISS-REFERENCE

This Application is a Continuation of U.S. Ser. No. 09/410,078 filed on Oct. 1, 1999, pending.

### BACKGROUND OF THE INVENTION

1. Field of the Invention

The present invention relates to systems for improving facial aesthetics and, more particularly, for at least partly removing or reducing the formation of ageing lines on the face.

2. Description of the Prior Art

With the ageing process, the skin loses its elasticity and cannot keep its original connection with the body's muscles. Therefore, when muscles repetitively contract to define different facial expressions, the associated skin contracts as well, but does not exactly return to its original position and shape thereby gradually creating fine lines and wrinkles.

Furthermore, during sleep, the muscles relax, skin sags down due to the forces of gravity and due to pressure exerted on the face by the bed and pillow. Consequently, continual use of the same sleeping position creates fine lines and wrinkles as a result of the fact that, with age, the skin loses its ability to bounce back after the sleep.

To try to maintain a youthful looking skin, various products, such as creams, have been developed which allegedly remove facial lines and/or prevent, or at least delay, the formation thereof.

U.S. Pat. No. 4,694,823 issued on Sep. 22, 1987 to Young discloses an apparatus for supporting chin, neck and facial tissue during sleep and including a neck-embracing lower attachment portion and an over-the-head criss-cross attachment portion for securely anchoring tissue engaging support portions to the lower chin and posterior jaw portions such as to provide uniform lifting on all of the engaged skin and neck areas to prevent and remove neck and facial sagging and wrinkling of the skin.

U.S. Pat. No. 4,934,357 issued on Jun. 19, 1990 to Frantzich et al. discloses a jaw support bandage for providing support to the jaw of a patient, for instance following oral surgery, or the like

U.S. Pat. No. 4,190,054 issued on Feb. 26, 1980 to Brennan discloses an elastic therapeutic bandage which is attachable to a body part for holding the flesh of the body part firmly in place and which comprises a flexible fluid retaining envelope that acts as a hot or cold pack.

U.S. Pat. No. 5,782,790 issued on Jul. 21, 1998 to Allen discloses a flexible compression and stabilizing orthotic made of a stretchable material and which is applied to a person afflicted with a neurological disorder, autism, proprioceptive and sensory deficits, or hypersensitivity.

U.S. Pat. No. 5,031,609 issued on Jul. 16, 1991 to Fye discloses a postoperative compression bandage for the head.

### SUMMARY OF THE INVENTION

It is therefore an aim of the present invention to provide a new system for at least partly removing or reducing the formation of ageing lines on the face.

It is also an aim of the present invention to provide a device as well as a method for at least partly removing or reducing the formation of ageing lines on the face.

Therefore, in accordance with the present invention, there is provided a method for reducing the formation of lines on the skin of a person, comprising applying pressure on the skin at locations where a reduction in said formation of lines is desired, said pressure being sufficient for at least partly impeding the development of said lines.

Also in accordance with the present invention, there is provided a device for reducing the formation of lines on the skin of a person, comprising mask means adapted to be positioned on the skin at locations where a reduction in the formation of lines is desired, and an attachment mechanism to secure said mask means to the head and/or neck of the person and being adapted to apply sufficient pressure at said locations for at least partly impeding the development of lines thereat.

### BRIEF DESCRIPTION OF THE DRAWINGS

Having thus generally described the nature of the invention, reference will now be made to the accompanying drawings, showing by way of illustration a preferred embodiment thereof, and in which;

FIG. 1 is a front elevational view of a device for at least partly removing or reducing the formation of lines, e.g. expression and/or sleep related lines, on the face in accordance with the present invention and shown in position on a user's face;

FIG. 2 is a side elevational view of the device and user of FIG. 1;

FIG. 3 is a rear elevational view of the device and user of FIG. 1;

FIG. 4 is a front elevational view of a device for at least partly removing or reducing the formation of lines, e.g. expression and/or sleep related lines, on the face in accordance with a second embodiment of the present invention and shown in position on a user's face;

FIG. 5 is a side elevational view of the device and user of FIG. 4;

FIG. 6 is a rear elevational view of the device and user of FIG. 4; and

FIG. 7 is a front elevational view of a human's face showing ageing lines on the prone areas thereof.

### DESCRIPTION OF THE PREFERRED EMBODIMENTS

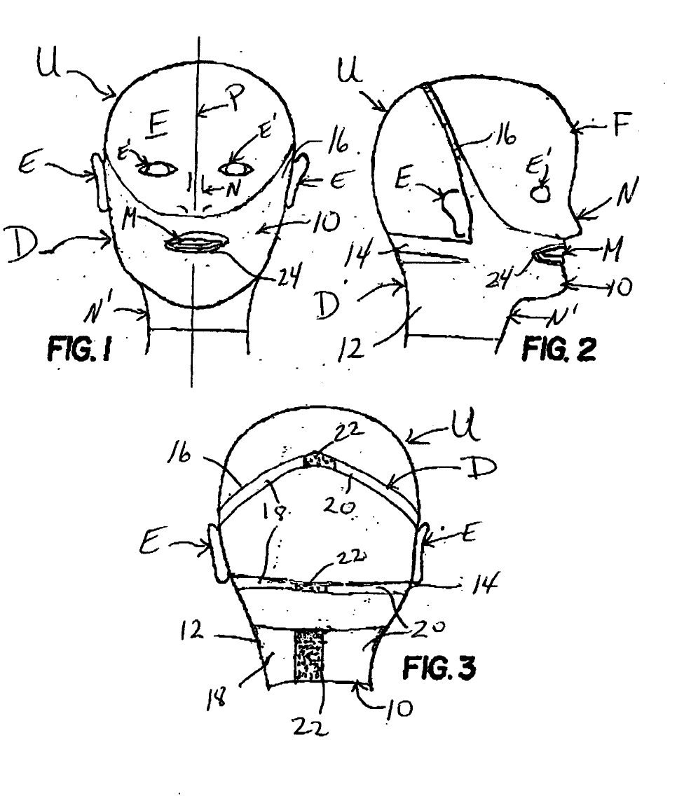

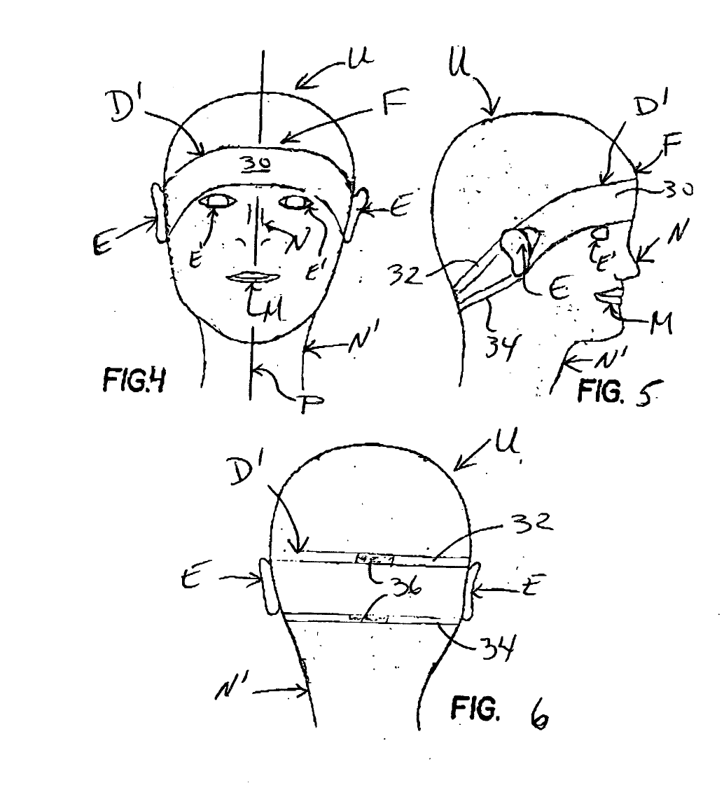

In accordance with the present invention, FIGS. 1 to 3 illustrate a first embodiment of a device D, shown positioned on a face of a user U, for at least partly removing or reducing the formation of facial expression lines, sleep related lines, sagging skin, etc, and which may be used by men and women alike. The device D is designed to counteract gravity forces, to provide sensory input to the brain, to create face shape awareness to the user U and keep the shape of the face substantially in its original form, i.e. similar to the shape of the face at one's youth. The device D prevents the skin from sagging during sleep, whereby no fine lines or wrinkles can appear.

The device D comprises a mask 10 adapted to cover the lower portion of the face, i.e. generally from below a nose N of the user U, and a neck N′ of the user U, and also comprises first, second and third straps 12, 14 and 16, respectively, to hold the mask 10 against the lower face and neck N′ of the user U. The first strap 12 surrounds the neck N′ (i.e. at the nape), with the second strap 14 extending around a lower portion of the user's head and slightly above the first strap 12, whereas the third strap 16 extends just in front of ears E of the user U and atop an upper rear portion of the user's head. Each of the first, second and third straps 12, 14 and 16 includes a pair of strap sections 18 and 20 extending from opposed sides of the mask 10, generally symmetrically about a vertical plane P, and joining together behind the users head and neck, for instance with Velcro™ strips 22. The mask 10 defines an opening 24 for the user's mouth M.

The device D may be made of a light, multidirectional stretchable, hygienic and comfortable material which does not alter or impede facial and neck blood circulation and allows the skin to breathe. The device D may also be made of a material having similar characteristics as above but which is not stretchable. The device D does not prevent the user U from using cosmetics and facial creams.

The device D operates to prevent or reduce the formation of lines on the face with dual action, that is as a result of the compression forces exerted on the skin by the actual physiological wearing of the device D and also the device D subconsciously stops the user U from frowning or making other facial expressions that would otherwise create lines and wrinkles. Indeed, during the active day or when the user U is sleeping, and without actual knowledge and special effort on the part of the user U, the brain, using biofeedback mechanisms, initiated by sensory input from the device D trains the user U away from the “bad” habits of making certain facial expressions which, when repeated sufficiently, ultimately create wrinkles.

The device D creates biofeedback between the user's skin, muscles and brain, to subconsciously control the formation of human behaviours and thereby assist in eliminating or reducing the formation of facial lines or wrinkles such as to impede early ageing of the user's U face.

Therefore, a method in accordance with the present invention provides sensory input and face shape awareness to the user U to stimulate the biofeedback between the brain, the muscles and the skin to prevent and correct facial fine lines and wrinkles. This is essentially achieved, for instance, by applying the present flexible compression and face stabilizing device D to the face of the user U so as not to produce lines of pull on the face but rather allow for complete freedom of neck and head movements and provide sensory input through a compression load to portion(s) of the face of the user U covered by parts of the device D, such as the mask 10 thereof.

The present device D and method associated therewith thus prevent or reduce the formation of sleep lines, fine lines and wrinkles on the face and neck of the user U, or reduce the depth thereof or eliminate previously formed such lines and wrinkles, by providing a compression and stabilising effect on the face and neck.

The areas of the face which are to be “treated” dictate the shape of the device. Indeed, the device D of FIGS. 1 to 3 constitutes a partial face-neck mask for lower face and neck area applications other devices may have masks for different applications, such as partial face, full face and full neck-face applications.

The device can thus be designed to cover one or more of the chin, neck, eye area, leaps, forehead, cheeks, etc.

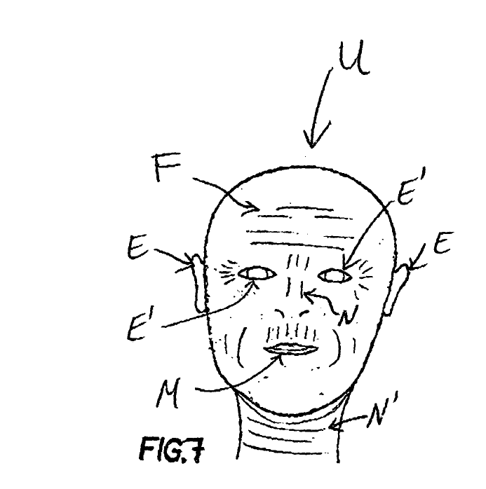

FIGS. 4 to 6 illustrate a variant device D′ intended for the forehead F of the user U and comprising a mask in the form of a band 30 extending along the forehead F and held in place by upper and lower straps 32 and 34, respectively, each having, for instance, a pair of strap sections attachable together with Velcro™ strips 36 (i.e. with a construction similar to that of the straps 12 to 16 of the device D of FIGS. 1 to 3). It is readily understood that other variants or constructions of the device can be made to cover various areas of the face and/or neck of the user U.

Also, the strap sections of the straps 12, 14, 16, 32 and 34 could be connectable together with attachment systems other than the Velcro™ strips 22 and 36. The straps 12, 14, 16, 32 and 34 could each be made in a unitary construction (as opposed to having two strap sections); in such a case, the straps 12, 14, 16, 32 and 34 could be made of an elastic material.

FIG. 7 shows the user U without any device thereon for illustrating typical areas of the face and neck where the device and method of the present invention may be applied as being prone to lines and wrinkles, e.g. the forehead F, the neck N, areas surrounding the mouth M, and areas around the eyes E′.

We claim:

1. A method for reducing the formation of lines on the skin of a person, comprising applying pressure on the skin at locations where a reduction in said formation of lines is desired, said pressure being sufficient for at least partly impeding the development of said lines.

2. A method as defined in claim 1, wherein said pressure is sufficient to at least partly impede the formation of facial expressions which cause said skin to wrinkle.

3. A method as defined in claim 2, wherein said pressure is applied for a sufficient amount of time such that biofeedback between the brain, muscles and skin subconsciously cause the person to reduce making said facial expressions.

4. A method as defined in claim 3, wherein said pressure is applied by way of a compression and face stabilising device which provides sensory input through a compression load on a portion of the face covered by said device.

5. A method as defined in claim 4, wherein said device prevents said skin from sagging during sleep thereby reducing said formation of lines during sleep.

6. A method as defined in claim 4, wherein said device smoothes out fine lines and wrinkles.

7. A method as defined in claim 4, wherein the brain using biofeedback mechanisms initiated by said sensory input from said device trains the person away from making said facial expressions.

8. A method as defined in claim 4, wherein said device is made at least at said locations of a light, breathable material to allow for freedom of neck and head movements.

9. A method as defined in claim 3, wherein said pressure is applied for at least one of: preventing sleep lines on said face, correcting fine lines and/or wrinkles, and preventing fine lines and/or wrinkles.

10. A method as defined in claim 4, wherein said device covers at least one of: a chin, a neck, eye-bordering areas, leaps, a forehead and cheeks.

11. A method as defined in claim 3, wherein said pressure results in at least one of; decrease in depth of lines and/or wrinkles, disappearance of facial and/or neck lines, and disappearance of facial and/or neck wrinkles.

12. A method as defined in claim 3, further including applying an anti-wrinkling cream on said skin.

13. A device for reducing the formation of lines on the skin of a person, comprising mask means adapted to be positioned on the skin at locations where a reduction in the formation of lines is desired, and an attachment mechanism to secure said mask means to the head and/or neck of the person and being adapted to apply sufficient pressure at said locations for at least partly impeding the development of lines thereat.

14. A device as defined in claim 13, wherein said attachment mechanism is adapted to cause said mask means to provide sufficient pressure to at least partly impede the formation of facial expressions, at said locations, which cause said skin to wrinkle.

15. A device as defined in claim 14, wherein said mask means comprise a compression and face stabilising means which provides sensory input through a compression load on a portion of the face covered by said mask means.

16. A device as defined in claim 14, wherein at least said mask means is made of a light, breathable material that allows for freedom of neck and head movements.

17. A device as defined in claim 14, wherein said mask means is adapted for being applied on at least one of: a chin, a neck, eye bordering areas, leaps, a forehead and cheeks.

18. A device as defined in claim 14, wherein said attachment mechanism comprises at least one strap extending from said mask means.

19. A device as defined in claim 18, wherein each said strap comprises a pair of strap sections connected at first ends thereof to said mask means and being detachably connectable together at second ends thereof for holding said mask means in position on said locations.

20. A device as defined in claim 19, wherein said second ends are provided with co-operating hook-and-loop strips.

21. A device as defined in claim 13, wherein said mask means comprises at least one of a band, a partial face mask, a full face mask, a partial face-neck mask, and a full face-neck mask.

22. A device as defined in claim 16, wherein at least said mask means is made of one of a multidirectional stretchable material and a non-stretchable material.

23. A device as defined in claim 13, wherein said mask means is used in combination with an anti-wrinkling cream adapted to be applied on the skin.
